(19) United States
(12) Patent Application Publication
(10) Pub. No.: US 2010/0057884 A1
(43) Pub. Date: Mar. 4, 2010

(54) BROWSER-BASED DOWNLOAD MANAGER

(76) Inventors: Jason Brownell, San Francisco, CA (US); Sherif Tawfik, Foster City, CA (US); Steve Ansell, Fremont, CA (US); Dan Kinney, Encinitas, CA (US); Kevin Campbell, Fremont, CA (US); Akhilesh Kumar, San Ramon, CA (US); Thierry Seegers, Sannyvale, CA (US); Jeff J. Liu, Fremont, CA (US)

Correspondence Address: FITCH EVEN TABIN & FLANNERY, 120 SOUTH LASALLE STREET, SUITE 1600, CHICAGO, IL, 60603-3406, US

(21) Appl. No.: 12/475,518

(22) Filed: May 30, 2009

Related U.S. Application Data
(60) Provisional application No. 61/057,738, filed on May 30, 2008.

(51) Int. Cl. G06F 15/16; G06F 17/30

(52) U.S. Cl. 709/219; 707/758; 709/227; 709/217; 380/277

(57) ABSTRACT

A file download manager automatically controls how and where downloaded files are stored. A method for use in downloading a file includes establishing communications between a network site and a computer that is visiting the network site, automatically detecting whether a device capable of receiving files is connected to the computer, automatically determining a location in the device where a file may be stored, and automatically downloading a file from the network site to the computer and sending the downloaded file to the device to be stored at the determined location in the device. A computer readable storage medium stores one or more computer programs adapted to cause a processor based system to execute these steps.

### CROSS-REFERENCE TO RELATED APPLICATIONS

This application claims the benefit of U.S. Provisional Patent Application No. 61/057,738, filed May 30, 2008, entitled “BROWSER-BASED DOWNLOAD MANAGER,” the entire disclosure of which is hereby incorporated by reference herein in its entirety.

### REFERENCE TO COMPUTER PROGRAM LISTING APPENDIX

The following computer program listing files are submitted herewith electronically with the filing of this application and are incorporated herein by reference in their entirety:

| NAME | CREATION DATE | SIZE (bytes) |
|---|---|---|
| Delivery_Metafile_Format.txt | 05/30/2009 | 71,000 |

### BACKGROUND OF THE INVENTION

1. Field of the Invention

The present invention relates generally to the downloading of files, and more specifically to the downloading of files to portable devices.

2. Discussion of the Related Art

Portable devices, such as hand-held devices, for playing games, music, videos, etc., have become very popular. Various different games, music, videos, etc., may be played on portable devices by downloading different files to the devices.

### SUMMARY OF THE INVENTION

One embodiment provides a method for use in downloading a file, comprising: establishing communications between a network site and a computer that is visiting the network site; automatically detecting whether a device capable of receiving files is connected to the computer; automatically determining a location in the device where a file may be stored; and automatically downloading a file from the network site to the computer and sending the downloaded file to the device to be stored at the determined location in the device.

Another embodiment provides a computer readable storage medium storing one or more computer programs adapted to cause a processor based system to execute steps comprising: establishing communications between a network site and a computer that is visiting the network site; automatically detecting whether a device capable of receiving files is connected to the computer; automatically determining a location in the device where a file may be stored; and automatically downloading a file from the network site to the computer and sending the downloaded file to the device to be stored at the determined location in the device.

A better understanding of the features and advantages of various embodiments of the present invention will be obtained by reference to the following detailed description and accompanying drawings which set forth an illustrative embodiment in which principles of embodiments of the invention are utilized.

### BRIEF DESCRIPTION OF THE DRAWINGS

The above and other aspects, features and advantages of embodiments of the present invention will be more apparent from the following more particular description thereof, presented in conjunction with the following drawings wherein:

FIG. 1 is a block diagram illustrating a system that operates in accordance with an embodiment of the present invention;

FIG. 2 is a flow diagram illustrating a method in accordance with an embodiment of the present invention;

FIG. 3 is a block diagram illustrating a layered architecture in accordance with an embodiment of the present invention;

FIG. 4 is a block diagram illustrating a use of the layered architecture in accordance with an embodiment of the present invention;

FIG. 5 is a screen shot diagram illustrating an example of device and delivery in accordance with an embodiment of the present invention;

FIG. 6 is a screen shot diagram illustrating an example of device and feed in accordance with an embodiment of the present invention;

FIG. 7 is a screen shot diagram illustrating an example of a delivery helper in accordance with an embodiment of the present invention;

FIG. 8 is a flow diagram illustrating a method in accordance with an embodiment of the present invention;

FIG. 9 is a flow diagram illustrating a method in accordance with an embodiment of the present invention;

FIG. 10 is a flow diagram illustrating a method in accordance with an embodiment of the present invention; and

FIG. 11 is a block diagram illustrating a computer or other processor based system that may be used to run, implement and/or execute the methods and techniques shown and described herein in accordance with the embodiments of the present invention.

### DETAILED DESCRIPTION

The Internet is fast becoming a viable platform for deploying interactive client applications. An increasing number of web sites are utilizing dynamic features and relying less on the traditional static page-based design. A number of well-known web applications such as Google Maps™ now offer a level of interactivity once only possible in desktop applications.

There are a growing number of companies, large and small, investing in the development of sophisticated applications, known as Rich Internet Applications (RIA), to replace desktop application functionality. These types of applications were previously developed mainly in web plug-in technologies. However, with the advent of AJAX techniques and modern web standards, a number of pure JavaScript SDKs are now available, as well as “hybrid” SDKs that extend or compile to JavaScript. These, along with the effort that browser makers are putting into JavaScript optimization, opens a wide range of approaches for developing RIAs in today's market.

On the mobile front, several devices include powerful web browsers capable of running rich applications within the browser alongside their native offerings. More devices with similar capabilities are expected, and developers are working hard to assure that the embedded browser landscape is as competitive as it is on the desktop.

It is believed that the web will become a dominant platform for deploying client applications. RIAs are believed to offer benefits that include cross-platform support, consistent interfaces, user-transparent updating and the ability to access applications from any location with an internet connection. Many of these benefits can help solve problems that developers face as their diverse array of products are enhanced with more sophisticated network and software features.

As such, some of the embodiments of the present invention provide one or more web-based applications, as well as hybrids of web and local applications. In some embodiments, a web-based helper application is provided that runs alongside existing media applications. In some embodiments, the helper application is capable of assisting with downloads, transfers and media management, as well as interactions with local applications, including one-way interactions with local applications. The web-based helper application may be deployed as an online application.

More specifically, some of the embodiments of the present invention provide a web-based helper application in the form of a file download manager that automatically controls how and where downloaded files are stored.

For example, in some embodiments, an online service provides a website that allows users to browse, search, and download music files through a web browser interface executing on a client system (connected to a server system supplying the website). When the user selects a file for download, a download manager provided by the online service manages the file download. The download manager may be implemented in various ways, such as a tool executing on the server or as a tool executing on the client, or as a combination.

The user interface for the download manager is supplied through the web browser used by the client system. A user provides information to the download manager to control the download, such as by clicking on options displayed in the web browser, or default settings are used. Alternatively, the web browser can suggest one or more options after investigating the state of the client system (e.g., what music software applications are installed).

In some embodiments, one aspect the download manager addresses is in what library to store the downloaded file. For example, if the user has previously stored music files in a library built with a particular company's software (e.g., Sony or Apple), the user may want to continue to store files in the same library. Through an appropriate setting in the download manager, the download manager will automatically add a downloaded file to the indicated library. It is noted that much of the description herein focuses on a music download service, but the techniques can be applied to other content as well (e.g., video or other audio, games, etc.).

In some embodiments, the download manager detects a device, such as a portable device, that is connected to a personal computer (PC). The website then downloads one or more files, such as music files, from the website to the portable device through the PC. That is, the website automatically detects the portable device and then automatically downloads one or more files, such as music files, to the portable device through the PC. The detection occurs automatically.

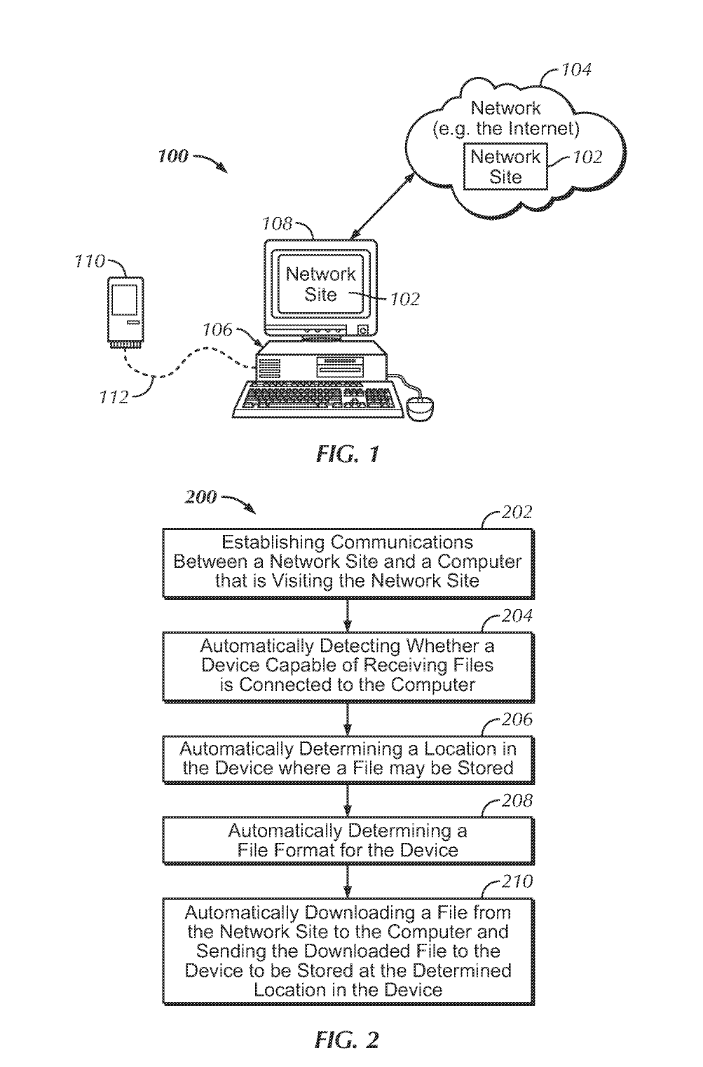

For example, FIG. 1 illustrates a system 100 that operates in accordance with an embodiment of the present invention. The system 100 includes a PC 106 having access to a network 104, such as the Internet. A portable device 110 is connected to the PC 106. The portable device 110 may comprise any type of portable device, such as a hand-held device, such as for playing games, music, videos, etc. By way of example, the portable device may comprise a Sony PlayStation Portable (PSP)™, or similar device. The portable device 110 may be connected to the PC 106 in many different ways, including wired and wireless connections, which are both represented by the dashed line 112.

In some embodiments, the PC 106 visits a network site 102, such as a website on the Internet. The network site 102 will typically be displayed on a display 108 of the PCT 106. The network site 102, such as a website, detects the portable device 110 and then downloads one or more files, such as music files, from the website 102 to the portable device 110 through the PC 106. In some embodiments, this may be referred to as a direct-to-device download. Namely, the website 102 automatically detects the portable device 110 and downloads to it through the PC 106. In addition, the website system may automatically detect what format the file should be, and then provide that file format to the device. In some embodiments, the website system may transcode the file format. In some embodiments, the website system may automatically determine what media types are supported by the device 110, such as for example audio, video, etc.

Referring to FIG. 2, there is illustrated a method 200 that operates in accordance with an embodiment of the present invention. The method 200 may be used for downloading files to a portable device. In some embodiments, the method 200 may be implemented by a web-based helper application in the form of a file download manager.

The method 200 begins in step 202 in which communications are established between a network site and a computer that is visiting the network site.

In step 204 the network site automatically detects whether a device capable of receiving files is connected to the computer. In some embodiments, the device comprises a portable device, such as any of those mentioned above. Such portable device may comprise a media player device. Thus, the website automatically detects the portable device. As mentioned above, the portable device may be connected to the computer in many different ways, including wired and wireless connections.

In step 206, a location in the device where a file may be stored is automatically determined. That is, the system may facilitate the investigation and detection of any available devices connected to the PC, and then facilitate the investigation and detection of any available storage locations in those devices. The system may perform these functions for the storage of files, such as music, video, game, etc., files.

For example, in some embodiments, the download manager includes the ability to automatically place files where they belong based on what it has learned about a user's PC and attached devices. A download manager in accordance with an embodiment of the present invention automatically decides where to place a file rather than the user having to specify the location. That is, the download manager decides where to place a file for the user.

In step 208, in some embodiments, a file format for the detected device is automatically determined. That is, the system automatically detects file formats and supported file types and codecs. The system may then provide that file format to the device. As mentioned above, in some embodiments, the system may transcode the file format.

In step 210, a file from the network site is automatically downloaded to the computer, and then the downloaded file is sent to the device to be stored at the determined location in the device. In this way, a file from the network site is automatically downloaded, through the computer, to the location in the device. That is, the file is downloaded from the website, through the PC, and then into the attached portable device. In some embodiments, a file download manager controls and manages the downloaded files from the website. As mentioned above, the download manager provided by the online service through a website interface can be implemented in various ways. This tool can be executed on the server or on the client, or as a combination. A user provides information to the download manager to control the download by using the default settings or by changing the settings. And again, the download manager can also store the files in already existing libraries built using a particular company's software.

Thus, a user may use a PC to visit a website having this system. The website then automatically detects whether a portable device is connected to the user's PC. The website may then automatically transfer files to the portable device through the PC in the correct file format. That is, the website detects a portable device attached to the user's PC and then automatically downloads to that portable device.

Embodiments of the present invention provide an interface for the downloading of files that involves fewer steps than conventional interfaces. That is, a user does not have to perform as many steps to download a file to a portable device as he or she would using conventional methods.

In some embodiments, another aspect the download manager may facilitate is the management of keys. The download manager (again through appropriate settings) can control where keys are stored and then access and provide the appropriate keys and key data when downloading files. The download manager further can control where the keys are stored and access the appropriate keys and key data when downloading files.

In some embodiments, as part of facilitating the management of keys, the system (i.e. the download manager) may, for example, handle licenses or any licensing issues. As another example, the system may facilitate the investigation and detection of any available devices connected to the PC for the use and storage of keys as well as files. Different keys may be involved. For example, there may be a key to get a file, and then another key to play the file.

Accordingly, some embodiments provide any one or more of the following features: a file download manager provided by the online service for managing the file download; a download manager, which allows users to browse, search and download files from a website provided by the online service; adding downloaded files to appropriate location based on settings in the download manager; and facilitating the management of keys using a download manager.

In some embodiments, the above-described web-based helper application provides immediate access to network download and device transfer of online content via a web-hosted application that works independently of any specific service or media management application. In some embodiments, it may include any one or more of the following functions: the initiation of content delivery by remote web services using a simple “one-click” interface that launches the Helper and adds content downloads into the queue; download management (pause, resume, delete) with digital rights management (DRM) transactions for licensed content seamlessly integrated into queue; direct transfer to any supported, connected devices including transfer after content has already downloaded; allow archiving content on the local PC as well as launching and importing into consumer's chosen media application; support for import and transfer of content from physical media (MemoryStick, Blu-Ray, etc.) as well as content downloaded over the Internet; and/or view device contents by media type and allow deleting to free up space.

The web-based helper application may be deployed as online application. It may be used for helping in the delivery of files. In some embodiments, it may be implemented to function with a variety of platforms (e.g. Windows XP, Windows Vista, Mac-OS 10.4, Mac-OS 10.5), browsers (e.g. Internet Explorer, Firefox, Safari), devices (e.g. PSP, Walkman, SEMC Phones, Mylo, Sony Reader, Handycam, DSC, GPS, Picture Frame), media applications (e.g. Windows Media Player, iTunes, Media Manager, eBook Library), DRMs (e.g. memory stick secure video (MSSV), Marlin, (eBook Marlin)), and/or connection protocols (e.g. Bluetooth, WiFi). Furthermore, in some embodiments, it may be implemented for various device integration (e.g. playlist creation, metadata editing, import from device), to provide various service features (e.g. RSS feeds (text, audio, video), content upload, download history), to function with third party services (e.g. locker services, photo upload, video upload, Facebook plug-in) and/or for various application integration (e.g. playlist creation, playback preview, device export via application). It should be noted that all of these various implementation details are optional and are not required.

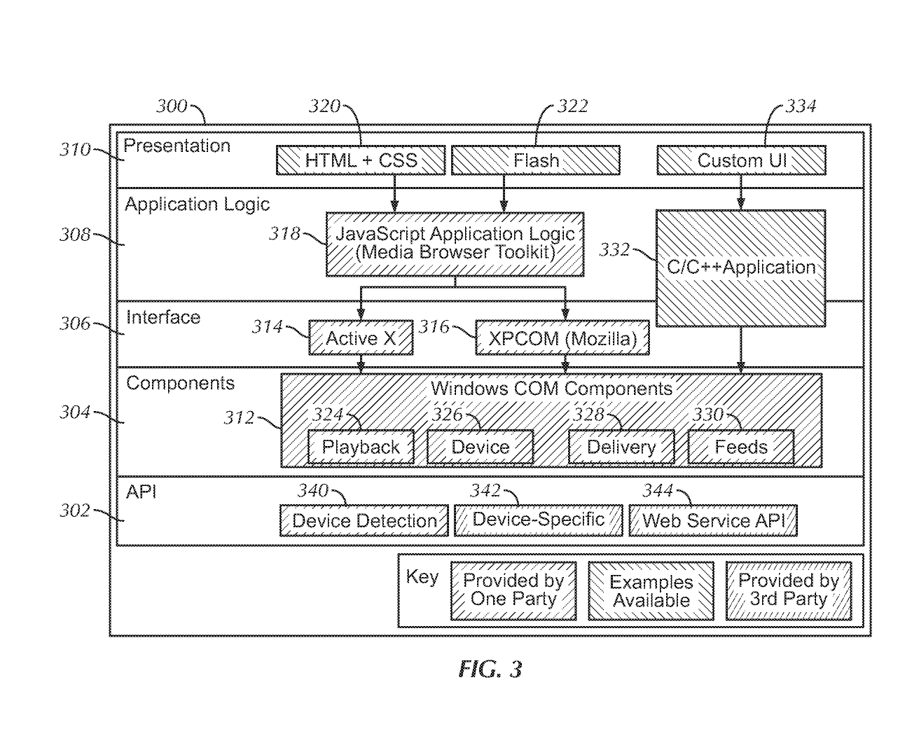

Referring to FIG. 3, there is illustrated a block diagram of an example layered architecture 300 that may be used for implementing a web-based helper application in accordance with an embodiment of the present invention. In some embodiments, the architecture 300 may comprise a traditional web browser plug-in built on top of layered component architecture. In some embodiments, the architecture 300 may comprise a web application written in JavaScript utilizing standard web technology or Flash for the user interface (UI).

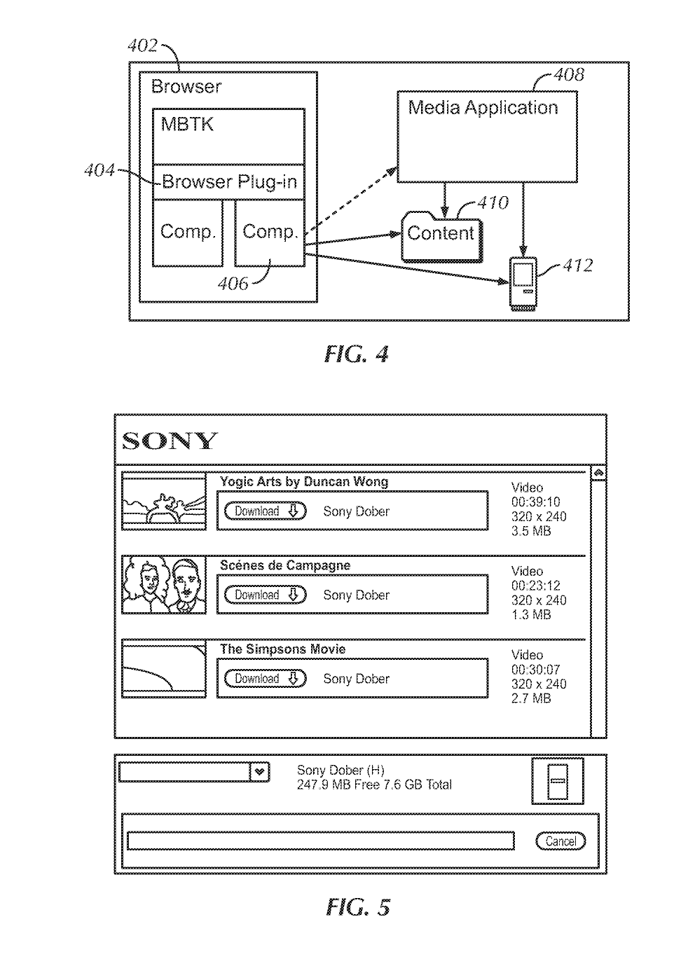

Some of the features of the layered architecture 300 are illustrated in FIG. 4. Shown are a browser 402 and a web browser plug-in 404 built on top of layered component architecture 406, in accordance with an embodiment of the present invention. An interface is provided to an external media application 408. In the illustrated embodiment the interface is unidirectional. The shared resources include content 410 and devices 412. In some embodiments, applications may be built on top of the component architecture 406. Code sharing may be performed in such an embodiment.

In some embodiments, the architecture 300 (FIG. 3) comprises an online media engine and the media browser toolkit. It includes a focus on media distribution and includes all necessary functions related to interfacing with media devices, utilizing content and interacting with network services. With respect to application level functionality, it includes a high-level application programming interface (API) with simple interfaces and event-driven feedback for abstract functions such as downloading, transferring and rendering. Furthermore, the architecture 300 includes a modular design with related functionality bundled into modular components that can be integrated into applications individually or used in tandem.

In some embodiments, the architecture 300 comprises a layered software approach. This enables flexibility to integrate into various application environments. In the illustrated example, the architecture 300 includes an API layer 302, a component layer 304, an interface layer 306, and application logic layer 308, and a presentation layer 310.

In some embodiments, the component layer 304 may use standard Windows COM technology components 312. In some embodiments, the component layer 304 may provide Macintosh support.

In some embodiments, the interface layer 306 may include Active-X support 314 for Internet Explorer and other hosted environments, and Cross Platform Component Object Model (XPCOM) support 316 for Firefox hosted applications (e.g. Mozilla). Native applications can talk directly to the COM Interface.

In some embodiments, the application logic layer 308 may have a Javascript application library 318 available for hosted applications. In some embodiments, the JavaScript application logic 318 may include a Media Browser Toolkit (MBTK).

In some embodiments, the presentation layer 310 provides support for standard web UI framework using HTML and CSS. In addition, Flash UI support may also be included. Thus, an HTML+CSS block 320, and a Flash block 322, may be included.

In the component layer 304, the Windows COM technology components 312 may include a playback component 324, a device component 326, a delivery component 328, and a feeds component 330.

The playback component 324 renders content in a number of different media types and formats. The device component 326 provides functionality for transferring to and managing content on a variety of connected devices. The delivery component 328 manages content downloads and related supporting service integration functions. And the feeds component 330 handles subscriptions to syndicated network content.

Regarding the functions of the playback component 324, the media types that may be supported include, for example, audio. In some embodiments, other media types may be supported, including video. The formats that may be supported include, for example, Adaptive Transform Acoustic Coding (ATRAC) (OpenMG w/SDK), as well as any DirectShow codec, as well as other formats. Streaming radio and network preview may be supported. Local content file playback may also be supported.

The API of the playback component 324, may include, for example, an initialization feature, including local file path, network file URL or radio metafile. It may include standard play controls, including play, pause, stop, and seek. It may include radio control, including next track, restrictions for seek and skip. By way of example, the playback component 324 may be used in SonicStage for ATRAC radio, web previews for audio services, web radio, video playback, e-book display, other streaming radio protocols, etc. By way of further example, the playback component 324 may be integrated into various services and support streaming previews and radio.

Regarding the functions of the device component 326, the media types that may be supported in some embodiments include audio, video, e-book. The formats that may be supported include, for example, ATRAC, MP3, AAC, WMA, MP4 Video, LRF, LRX, and MSSV. The devices that may be supported include, for example, PSP, PRS, SEMC Phones, Walkman. The functions may also include, for example, device identification, content export, and view device content.

The API of the device component 326, may include, for example, an initialization feature that monitors and waits for device connection, and an identification feature that includes the device name, model and other available data. For content export, the transfer progress may be provided via events. The device content may include metadata for supported formats. By way of example, the device component 326 may be used in, for example, services used for downloading video to portable decides, such as for example the PSP, Phones, Walkman, etc. In some embodiments, additional features may include media transfer protocol (MTP), transcoding, image support, metadata editing, playlists, etc. By way of example, the device component 326 may be integrated into services that, for example, provide device detection, and download and transfer to portable devices, such as for example the PSP, SEMC Phones, Walkman devices, etc.

Regarding the functions of the delivery component 328, it may be media and format agnostic for downloading. DRM support may include, for example, Marlin, OpenMG, MSSV, etc. It may include a delivery metafile for grouping, ordering and metadata. It may additional include functions such as content download, service registration, license acquisition.

The API of the delivery component 328, may include, for example, an initialization feature that includes a local or URL-specified metafile. Download management may include, for example, start all, start group, stop and resume. It may include persistent storage in that the current download queue is saved/restored on disk. Metadata may be available at group or individual item level. By way of example, the delivery component 328 may be integrated into various services for video download and/or used for service integration and content download. In some embodiments, additional features may include WM-DRM support and BITS interface for download. By way of further example, the device component 326 and delivery component 328 may, in some embodiments, provide full device support and download queuing. An example is illustrated in FIG. 5.

Regarding the functions of the feeds component 330 (FIG. 3), it may be media and format agnostic. A feed subscription may use, for example, RSS 1.0, RSS 2.0, ATOM. A management of subscription and download state function may be included. Additional functions may include, for example, device integration with per-device feed management.

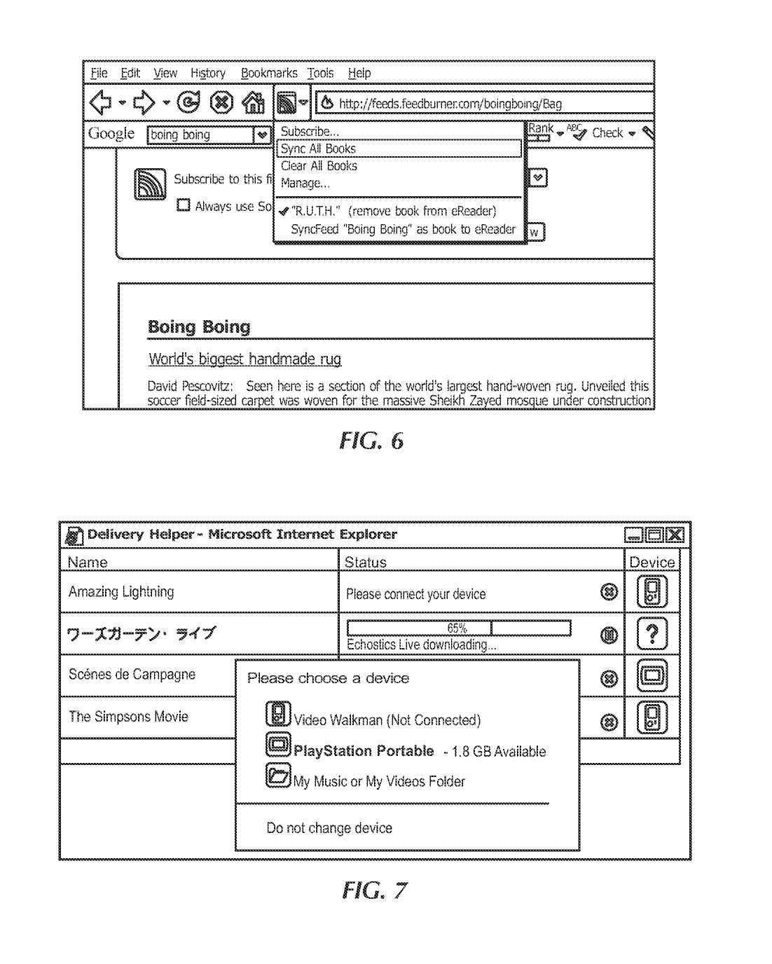

The API of the feeds component 330, may include, for example the ability to: add, view and manage feeds; initiate downloads and progress feedback; perform device transfer with integrated device component; and/or storage and management of subscription state on device. By way of example, the feeds component 330 may, in some embodiments, provide a feed toolbar, automation of subscription download, and/or scheduling functionality. Such a feed toolbar may comprise a browser add-on for subscribing to feeds and transferring them to certain devices. An example is illustrated in FIG. 6.

As mentioned above, the application logic layer 308 (FIG. 3) may include JavaScript application logic 318. In some embodiments, the JavaScript application logic 318 may include a Media Browser Toolkit (MBTK). Its functionality may include, for example, JavaScript interfaces that wrap the functionality of the Media Components (Playback, Device, Delivery and Feeds). Utility functions may also be included for managing and working with component interfaces. Example UI functionality may be included for convenience and demonstration purposes.

In some embodiments, the supported platforms may include a browser abstraction layer that enables seamless use within both IE or Firefox web browsers. In some embodiments, support may also be provided for other Mozilla application containers such as XULRunner.

The programming interface of the MBTK may, for example, include object-oriented JavaScript interface for each component. A callback registration API may be provided for handling events and error conditions. And in some embodiments UI examples may be built on popular user interface libraries. In some embodiments, the delivery helper application may comprise a full-featured download and device manager, which may, for example, comprise a sophisticated web application using MBTK. FIG. 7 illustrates a delivery helper application in accordance with an embodiment of the present invention.

In some embodiments, the architecture 300 (FIG. 3) may be implemented in web application code. Web pages may integrate the components and include full source code written on top of the Media Browser Toolkit. Such web pages may be useful as a starting point for web application development, as well as for verifying functionality of delivered components.

In some embodiments, Windows C++/MFC (Microsoft foundation class library) applications 332 may be used. A custom UI 334 may also be used. In some embodiments, very low-level applications may be used for validating API, messaging and baseline functionality. Furthermore, they may be used for internal testing of each component before release, including automated regression testing. Such test applications, their source code, as well as other custom C++ example code, may or may not be included with the architecture 300.

In some embodiments, the API layer 302 may include a device detection block 340, a device-specific block 342, and a web service API 344. The device detection API 340 and the device-specific API 342 are used for detecting whether a device, such as a portable device, is connected to the personal computer (PC), and for determining the specific type of device that is connected. This device detection component will be discussed in more detail below.

Thus, as described above architecture 300 may be used for implementing a web-based helper application in accordance with an embodiment of the present invention. Various components of the architecture 300 may be programmed and integrated into an application. Supporting scripts may be made available for one or more components.

In some embodiments, the system, website, and/or web-based helper application may comprise a (1) device detection component, and a (2) delivery component. The following discussion provides examples embodiments. In some embodiments, a delivery metafile may define and script the download.

In some embodiments, the device detection component (1) automatically determines the identity of the device that is connected to the PC. In some embodiments, the identity of the device is automatically determined by looking up the device in a local database of devices. For example, the computer looks up the device and attempts to match the device with what is in the database. The local database captures information about the various devices. The local database may be periodically automatically updated. In some embodiments, the local database may be dynamically updated. In some embodiments, the database may be in an XML format or schema. In some embodiments, if the device is not found in the local database, then the system may access a server via the Internet to check if there is a new specification file on the server that includes information for the device.

More specifically, in some embodiments, the device detection component (1) may comprise a dynamic device discovery feature. One purpose of this feature is to allow new devices to be recognized without requiring an update to the software components. So long as a new device is within the supported functionality of the components and uses one of the supported connection protocols, it should be possible to support it simply by acquiring a set of specifications for the device. The specification will contain identifying information about the device as well as the supported media types and formats. A local set of specifications will define what is currently supported by the software. The device specifications can then be updated by downloading from a central server location. When a device is attached that is not identified by the local configuration, the software will check to see if there is a new specification file on the server that includes the new device. Devices that can be completely identified by their supporting protocol such as MTP devices, can be utilized in the system even if they are not in the specification file.

In some embodiments, an XML Configuration File may be used for device identification. Specifically, in some embodiments, the software may utilize an external XML file stored on the local file system that will contain all of the detailed information about supported devices. The XML file may include one entry for each supported device uniquely identified by its vendor and product IDs. Each device entry within the XML file may contain an “identifications” section which provides a list of user-displayable identification information for the device.

In some embodiments, the identifications section for a device may contain at least one “identification” section, each of which provides information in a specified language. The identification language may be presented using standard 2-letter language codes (ISO 639) and optional 2-letter country codes (ISO 3166). The first identification section listed for a device may be considered the default. The information in the identification section may be used by applications to display detailed information about the particular device.

In some embodiments, the identification section may contain some or all of the following information:

Vendor: The name of the company that produces the device (e.g. Sony, “Sony Ericsson”);

Model: The model descriptor for the device (e.g. “NWZ-A720 series”);

Category: A classification for devices of similar functionality (e.g. “Mobile phone”);

Brand: The brand given to a set of devices by the vendor (e.g. Walkman);

Description: A string providing additional details about the device (e.g. “mylo 2 Personal Communicator connected as an MTP device”); and

Friendly Name: A user-presentable name for the device (e.g. “Walkman (A720 series”).

In some embodiments, each device entry within the XML file may contain a “storages” section to represent the memory storage locations available on the device. Each storages section for a device may contain at least one “storage” section. A storage section can be one of two types, either “fixed” or “removable”. Storages of type fixed may contain a “capacity” element indicating the amount of physical storage in the device. Storages of type removable may include a “media” element that indicates the type of external storage media that is supported. By way of example, the media element may be of type “Memory_Stick” or “Secure_Digital”.

In some embodiments, each device entry within the XML file may contain an “interfaces” section defining the supported physical and logical interfaces used to connect to the PC. Each interfaces section for a device may contain at least one “interface” section. The interface section includes an attribute that defines the physical connection. By way of example, “USB” and other standards may be supported. The interface section may include a “version” element that defines the USB version that the device supports. The interface section may include a “class” element that defines the logical connection protocol. By way of example, the interface class can be one or more of the following: MSC (device connected using the USB Mass Storage Class specification); MTP (device connected using Microsoft's Media Transfer Protocol); FF (device connected as a USB raw device using a proprietary protocol).

In some embodiments, each device entry within the XML file may contain a “firmwares” section that contains a list of firmware versions and the media types supported by them. The firmwares section for a device may contain at least one “firmware” section. The firmware section is identified by a version attribute that contains the version string for the firmware as reported by the device.

In some embodiments, each firmware section may include at least one “media” section specifying the media types supported by the device. The media section may include a “type” attribute specifying the media type to which it refers. Supported media types may include one or more of the following: video, audio, image, text, ringtone, theme, game, etc.

In some embodiments, a media type entry may be defined by a “path” or set of “paths” and the formats that may be stored there. A paths element may include one or more “path” elements. A path element may specify either a physical directory on the device or a “scheme” such as “Memory_Stick” that refers to a built in algorithm for determining the directory and file name used to store supported content.

In some embodiments, a media type entry may include one or more “format” entries identified by a format-specific type identifier. In some embodiments, one or more of the following types may be supported:

Audio Types: Dolby, MPEG, MPEG4, WindowsMedia, WAV, PCM;

Video Types: MemoryStick, MPEG4, AVCHD, WindowsMedia;

Text Types: Broadband_eBook, IDPF_epub, Portable_Document, text, Rich_Text, Word;

Image Types: JPEG, bitmap, Portable_Network_Graphics, Graphics_Interchange, Tagged_Image_File; and

Other Types: PSP_theme, PSP_game.

In some embodiments, the format entry may contain an “extensions” entry which lists the possible file extensions for types identified as this format. The format entry may also include entries for format-specific data (e.g. codec) used to determine if the device can support specific files.

In some embodiments, the format entry may include an entry for a “thumbnail” to be displayed in the device UI. The thumbnail entry may include a type attribute that will contain one of the valid image types supported by the device. The thumbnail entry may contain an “extensions” entry which lists the possible file extensions for the thumbnail. The thumbnail entry may also contain entries listing further constraints on the thumbnail file such as the file size or dimensions.

Some embodiments of the present invention provide for online update of supported devices. When a device is connected the software may first check to see what the vendor of the device is (e.g. Sony or Sony Ericsson, or some other vendor). If the device contains a vendor ID other than a certain vendor (e.g. Sony or some other vendor) then in some embodiments it may only be supported if it is an MTP protocol device. If the device is an MTP device then it can be supported by containing a specification file on the device itself. If the MTP device does not contain a specification file then it may be supported using the information obtained generic MTP interfaces.

In some embodiments, for non-MTP devices, the software may consult a local “blacklist” file which lists the devices that are explicitly not supported by the system. The blacklist file may contain a list of devices identified by vendor and product IDs. If the device is a device by a certain vendor and is not in the blacklist, the software may search the local specification for a matching entry. If the device is found within the local specifications, the information within that file may be used to identify the device, its resources and capabilities. If a connected device is not found within the local specifications the software may check for updated specifications from the server. If an updated blacklist file is found on the server it may be downloaded and checked to see if the device should be ignored. If an updated specification file is found on the server it may be downloaded and checked to see if the device should be supported.

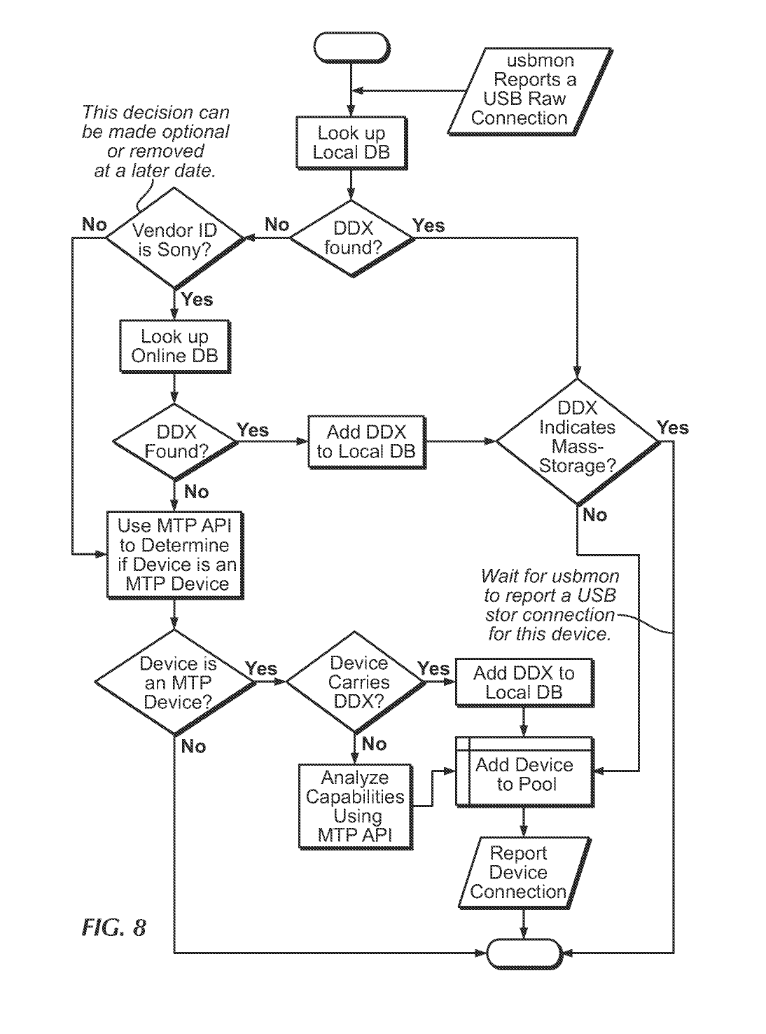

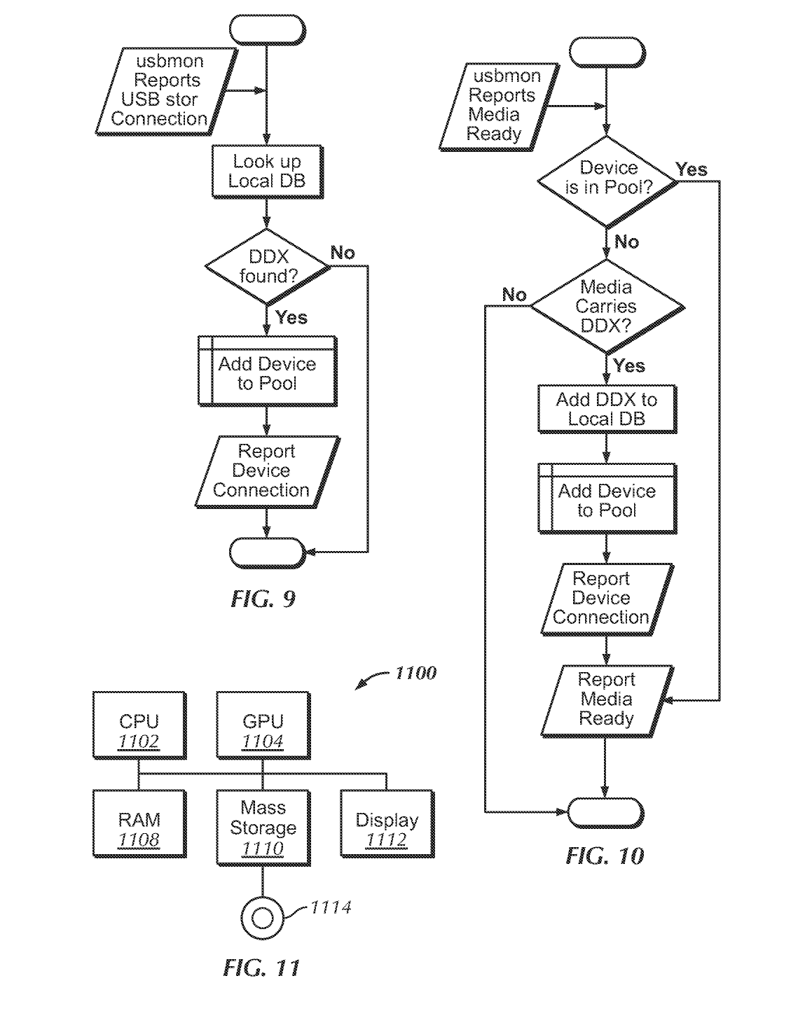

FIGS. 8, 9 and 10 are flow diagrams illustrating methods in accordance with embodiments of the present invention. In some embodiments, such methods may be used to provide for online update of supported devices.

Some embodiments of the present invention provide for content bundle support. Namely, in some embodiments certain types of media are comprised of multiple files that make up a single content item (i.e. PSP games). In order to support this type of content it is preferred to deliver it as single collection of files that can then be transferred as multiple files to the device. Furthermore, it is desirable to allow content providers the ability to bundle up a collection of different types of content to be delivered as a single unit. This content may be downloaded and transferred as a single item, but it will end up as multiple items on the final device. Bundles should preferably be able to be delivered to any device that supports at least one of the content types within it.

In some embodiments, bundle files may be handled as follows. Bundles may consist of files in the ZIP archive and data-compression format identified by the “.zip” file extension. The bundle may contain at least one content items in a format supported by the system. The bundle may contain any number of content items and may also contain a mix of items of varying formats. The bundle may contain an XML manifest file to identify and provide details about the contents of the bundle.

In some embodiments, bundle files are exported to a device as a single unit; the application cannot individually transfer items within the bundle. When a bundle is exported to a device all of the content items in the bundle that are supported by that device will be exported. During export, content items not supported by a particular device may be ignored and no error or status information will be given.

In some embodiments, if a bundle includes a manifest file then only those content items identified in the manifest (and supported by the device) may be transferred. When a bundle is exported the software may deliver progress messages to the application for the bundle as a whole. When a bundle is exported the software may also delivery individual progress messages to the application for each content item exported. If a content item fails to export an error indication may be delivered in the “transfer end” message, but the software may proceed to the next item.

In some embodiments, game content, such as for example PlayStation Portable game content or other game content, may be handled as follows. PSP Game content items consist of a directory containing a PBP file along with a collection of other files used by the game. In some embodiments, the only way to export PSP Game content to a device is by including it in a bundle file. If the bundle file does not contain a manifest then the software may recognize a PSP game by the existence of folder containing a PBP file.

In some embodiments, the destination location for exporting will be based on the name of the folder containing the game files. When a game item is exported all of the files within the directory with the PBP file may be exported to the destination. In some embodiments, when a game item is exported, item-level progress messages may be delivered to the application for the game as a whole; not for individual files. When the list of content items is queried from the DeviceManager interface, the game may be represented as a single object. If the game content is deleted from the DeviceManager interface, then the folder and all of its contents may be deleted.

In some embodiments, bundle manifest XML may be handled as follows. If the bundle includes a manifest file it may be named “manifest.xml” and not be in any sub-directory of the ZIP file. The manifest file may consist of one or more “media” entries that specify a collection of media files. The media section may include a “type” attribute specifying the media type of the files to which it refers.

In some embodiments, the media types that may be supported may include the following: video, audio, image, text, ringtone, theme, game, etc. Other media types may also be supported. A media type entry may be defined by a “path” or set of “paths” and the formats that may be stored there. A paths element may contain one or more “path” elements. Each path element may contain a path to an individual content item fully qualified within the ZIP.

In some embodiments, a media entry may include one “format” entry identified by a format-specific type identifier. The types that may be supported include:

Audio Types: Dolby, MPEG, MPEG4, WindowsMedia, WAV, PCM;

Video Types: MemoryStick, MPEG4, AVCHD, WindowsMedia;

Text Types: Broadband_eBook, IDPF_epub, Portable_Document, text, Rich_Text, Word;

Image Types: JPEG, bitmap, Portable_Network Graphics, Graphics_Interchange, Tagged_Image_File; and

Other Types: PSP_theme, PSP_game.

In some embodiments, the format entry may contain an “extensions” entry which lists the possible file extensions for types identified as this format. The format entry may also includes entries for format-specific data (i.e. codec) to further identify the specific content items. When exporting a bundle containing a manifest file, the media entry may be used to match against formats supported by the device. When exporting a bundle containing a manifest file, only those files specified in the manifest may be exported.

Some embodiments of the present invention provide for device playlist support. Namely, many devices support the concept of a “playlist” for time-based media content. A playlist consists of a list of content items, usually audio, that will be played in a specified order one after the other when the user selects the playlist item. Some devices support playlists as files in a standard format such as M3U while others support the feature via a proprietary interface. In order to support playlists that can be downloaded or imported from the local system to be sent to devices, support for device playlists should be added. To support this feature, playlists can be created on a device, content added to the playlists and delete device playlists. Also, it is desirable to be able to directly send a playlist to a device and have it created on the device including exporting the necessary content. These features will be supported via new APIs on the DeviceManager component and exposed via the MBTK JavaScript. Changes will be made to the test page in order to utilize these features.

In some embodiments, playlist APIs may be handled as follows. The software may contain an interface (ExportPlaylist) for exporting a playlist file to a device given the path to the file and a name for the playlist. The software may support exporting of playlist files in the M3U format. When a playlist file is exported to a device a device-side playlist may be created. When a playlist file is exported to a device each of the content files listed in the playlist file may be exported to the device. When a playlist is exported messages may be sent to the application to indicate start, end and progress of the playlist export. When a playlist is exported progress messages may also be sent for each of the files exported as part of the playlist.

In some embodiments, the software may contain an interface (CreatePlaylist) for creating a playlist on the device given a list of file identifiers and a name for the playlist. The list of file identifiers may consist of ids for files that are already on the device. When a playlist is created using CreatePlaylist the entries in the playlist may be ordered according to the list of file identifiers. The software may contain an interface (ExportToPlaylist) that adds entries to an existing playlist given a playlist name and a list of files.

In some embodiments, when files are exported to a playlist each of the files in the list of files may be exported to the device. When files are exported to a playlist they may be appended to the end of the playlist. When files are exported to a playlist they may be added in the order in the same order as they are contained in the list of files. When files are exported to a playlist messages may be sent to the application to indicate start, end and progress of the playlist update. When files are exported to a playlist progress messages may also be sent for each of the files added to the playlist.

In some embodiments, the software may contain an interface (ImportPlaylist) for importing from a device playlist into a local file given a playlist id and a destination directory. The software may support importing of playlists into the M3U format. When a playlist is imported from a device an M3U file may be created on the local system using the name of the device playlist. When a playlist is imported from a device each of the content files listed in the playlist may be imported from the device to the destination directory. When a playlist is imported from a device messages may be sent the application to indicate start, end and progress of the import. When a playlist is imported progress messages may also be sent for each of the files imported.

In some embodiments, the software may include an interface (ImportToPlaylist) that adds entries to an existing playlist file given a playlist file, list of item ids and a directory. When files are imported into a playlist each of the content items in the list of item ids may be imported from the device to the destination directory. When files are imported into a playlist the imported files may be appended to the end of the playlist file. When files are imported into a playlist the order of the files may be that represented by the list of item ids. When files are imported into a playlist messages may be sent to the application indicating start, end and progress of the playlist update. When files are imported into a playlist messages may also be sent for each of the files being imported.

In some embodiments, the software may include an interface (DeletePlaylist) that takes a playlist id and deletes the playlist from the device. When a device playlist is deleted, the content items referred to in the playlist may not be deleted. The software may include an interface (GetPlaylistIDs) for retrieving the list of playlist ids on the device. The software may include an interface (GetPlaylistByID) in order to obtain a playlist object with detailed information about a playlist. The playlist object may include an interface for retrieving the name of the playlist. The playlist object may include an interface (GetItemIDs) for retrieving the list of item ids that are in the playlist. The order of the item ids returned in the list may represent the order of the content items in the playlist.

In some embodiments, the delivery component (2) (mentioned above) coordinates the downloading of content to the device that is connected to the PC. As mentioned above, in some embodiments, a delivery metafile may define and script the download.

The above-mentioned computer program listing appendix includes a text file entitled “Delivery_Metafile_Format.txt”, which is being electronically submitted herewith and which is incorporated by reference herein in its entirety.

The document included in “Delivery_Metafile_Format.txt” describes an example format of a file that may be used to specify how to accomplish a delivery to network enabled applications, in accordance with an embodiment of the present invention. The Delivery Metafile may be used to pass information required for network communication and transactions supported by the client application components.

In some embodiments, the Delivery Metafile Format establishes a generic protocol for delivering payloads to a client and executing transactions between a client and a server. It is independent of media type, content file format or DRM system. Though targeted for electronic media distribution, there is nothing in the format that precludes its use for delivering arbitrary payloads, such as software components.

The specification may also be referred to as the “DMF” (Delivery Metafile Format) specification.

In some embodiments, the Delivery Metafile may be used for at least two purposes. First, it may be used to provide the parameters needed by the client/server protocol to complete a delivery request. A delivery may contain one or more items. Second, it may be used to provide information to present to the consumer during a delivery. It is not intended to impose any particular service-specific policies or determine how the client/server protocol is to be used. However, it can allow a service to describe its policy to the client application so that this policy may be carried out.

In some embodiments, the Delivery Metafile format can be used in multiple applications. By way of example, two such applications may include:

Downloading: The Delivery Metafile may be used to specify an Electronic Media Distribution (EMD) transaction, including the parameters needed for content and license acquisition as well as service registration; and

Streaming: The Delivery Metafile may be used to specify the parameters needed to define the ATRAC Radio Streaming protocol.

In some embodiments, the format for the Delivery Metafile used for downloading and streaming may use the same format. They are given separate identifiers in order to facilitate client application use and avoid confusion.

In some embodiments, the file format definitions may be as follows. By way of example, MIME Type may be as follows:

Downloading: When transmitted over a network, the MIME type associated with the EMD metafile may be application/x-______-xdmd.

Streaming: When transmitted over a network, the MIME type associated with the streaming metafile may be application/x-______-xdms.

In some embodiments, by way of example, Extension may be as follows:

Downloading: When stored on a local hard disk, the file extension for the EMD metafile may be .xdmd. In some embodiments, the specification allowed for the extension to be “.dmf”.

Streaming: When stored on a local hard disk, the file extension for the streaming metafile may be .xdms. In some embodiments, the specification allowed for the extension to be “.dms”.

In some embodiments, the eXtensible Markup Language (XML) may be used to hold the contents of the Delivery Metafile.

In some embodiments, the order of processing for any particular delivery may be explicitly defined using the delivery metafile. In some embodiments, the processing order may follow two rules for synchronization purposes: ordering is expected to be synchronous and sequential within a <Group> element; and the delivery of sibling <Group> elements can be processed asynchronously.

The methods and techniques described herein may be utilized, implemented and/or run on many different types of systems. Referring to FIG. 11, there is illustrated a system 1100 that may be used for any such implementations. One or more components of the system 1100 may be used for implementing any system or device mentioned above, such as for example any computers, servers, website servers, devices, portable devices, etc. However, the use of the system 1100 or any portion thereof is certainly not required.

By way of example, the system 1100 may include, but is not required to include, a central processing unit (CPU) 1102, a graphics processing unit (GPU) 1104, a random access memory (RAM) 1108, and a mass storage unit 1110, such as a disk drive. The system 1100 may be coupled to, or integrated with, any of the other components described herein, such as a display 1112. The system 1100 comprises an example of a processor based system. The CPU 1102 and/or GPU 1104 may be used to execute or assist in executing the steps of the methods and techniques described herein, and various program content, images, etc. may be rendered on the display 1112.

The mass storage unit 1110 may include or comprise any type of computer readable storage or recording medium or media. The computer readable storage or recording medium or media may be fixed in the mass storage unit 1110, or the mass storage unit 1110 may optionally include removable storage media 1114, such as a digital video disk (DVD), Blu-ray disc, compact disk (CD), USB storage device, floppy disk, or other media. By way of example, the mass storage unit 1110 may comprise a disk drive, a hard disk drive, flash memory device, USB storage device, Blu-ray disc drive, DVD drive, CD drive, floppy disk drive, etc. The mass storage unit 1110 or removable storage media 1114 may be used for storing code or macros that implement the methods and techniques described herein.

Thus, removable storage media 1114 may optionally be used with the mass storage unit 1110, which may be used for storing code that implements the methods and techniques described herein, such as code for running the above-described web-based helper application, download manager, device detection schemes, device update schemes, delivery component, etc. However, any of the storage devices, such as the RAM 1108 or mass storage unit 1110, may be used for storing such code. For example, any of such storage devices may serve as a tangible computer readable storage medium for storing or embodying a computer program for causing a computer, server, or other processor based system to execute or perform the steps of any of the methods, code, and/or techniques described herein. Furthermore, any of the storage devices, such as the RAM 1108 or mass storage unit 1110, may be used for storing any needed database(s).

In some embodiments, one or more of the embodiments, methods, approaches, and/or techniques described above may be implemented in a computer program executable by a processor based system. By way of example, such processor based system may comprise the processor based system 1100, or a computer, server, entertainment system, game console, graphics workstation, etc. Such computer program may be used for executing various steps and/or features of the above-described methods and/or techniques. That is, the computer program may be adapted to cause or configure a processor based system to execute and achieve the functions described above. For example, such computer program may be used for implementing any embodiment of the above-described steps or techniques. As another example, such computer program may be used for implementing any type of tool or similar utility that uses any one or more of the above described embodiments, methods, approaches, and/or techniques. In some embodiments, the computer program may comprise any type of software, such as system software, a macro, a utility, program code, or other type of software. In some embodiments, program code macros, modules, loops, subroutines, etc., within the computer program may be used for executing various steps and/or features of the above-described methods and/or techniques. In some embodiments, the computer program may be stored or embodied on a computer readable storage or recording medium or media, such as any of the computer readable storage or recording medium or media described herein.

Therefore, in some embodiments the present invention provides a computer program product comprising a medium for embodying a computer program for input to a computer and a computer program embodied in the medium for causing the computer to perform or execute steps comprising any one or more of the steps involved in any one or more of the embodiments, methods, approaches, and/or techniques described herein. For example, in some embodiments the present invention provides a computer readable storage medium storing one or more computer programs adapted to cause a processor based system to execute steps comprising: establishing communications between a network site and a computer that is visiting the network site; automatically detecting whether a device capable of receiving files is connected to the computer; automatically determining a location in the device where a file may be stored; and automatically downloading a file from the network site, through the computer, to the location in the device.

The above description is not to be taken in a limiting sense, but is made merely for the purpose of describing the general principles of exemplary embodiments. The scope of the invention should be determined with reference to the claims.

What is claimed is:

1. A method for use in downloading a file, comprising:
establishing communications between a network site and a computer that is visiting the network site;
automatically detecting whether a device capable of receiving files is connected to the computer;
automatically determining a location in the device where a file may be stored; and
automatically downloading a file from the network site to the computer and sending the downloaded file to the device to be stored at the determined location in the device.

2. The method of claim 1, wherein the device comprises a portable device.

3. The method of claim 2, wherein the portable device comprises a media player device.

4. The method of claim 1, further comprising:
automatically determining a file format for the device.

5. The method of claim 1, further comprising:
automatically determining an identity of the device.

6. The method of claim 5, wherein the automatically determining an identity of the device comprises:
looking up the device in a local database of devices.

7. The method of claim 5, wherein the automatically determining an identity of the device comprises:
accessing a server via the Internet to check if there is a new specification file on the server that includes information for the device.

8. The method of claim 1, further comprising:
automatically managing keys by controlling where keys are stored and access and provide the appropriate keys and key data when downloading files.

9. A computer readable storage medium storing one or more computer programs adapted to cause a processor based system to execute steps comprising:
establishing communications between a network site and a computer that is visiting the network site;
automatically detecting whether a device capable of receiving files is connected to the computer;
automatically determining a location in the device where a file may be stored; and
automatically downloading a file from the network site to the computer and sending the downloaded file to the device to be stored at the determined location in the device.

10. The computer readable storage medium of claim 9, wherein the device comprises a portable device.

11. The computer readable storage medium of claim 10, wherein the portable device comprises a media player device.

12. The computer readable storage medium of claim 9, wherein the one or more computer programs are further adapted to cause a processor based system to execute steps comprising:
automatically determining a file format for the device.

13. The computer readable storage medium of claim 9, wherein the one or more computer programs are further adapted to cause a processor based system to execute steps comprising:
automatically determining an identity of the device.

14. The computer readable storage medium of claim 13, wherein the automatically determining an identity of the device comprises:
looking up the device in a local database of devices.

15. The computer readable storage medium of claim 13, wherein the automatically determining an identity of the device comprises:
accessing a server via the Internet to check if there is a new specification file on the server that includes information for the device.

16. The computer readable storage medium of claim 9, wherein the one or more computer programs are further adapted to cause a processor based system to execute steps comprising:
automatically managing keys by controlling where keys are stored and access and provide the appropriate keys and key data when downloading files.
